(19) United States
(12) Patent Application Publication
(10) Pub. No.: US 2025/0016192 A1
(43) Pub. Date: Jan. 9, 2025

(54) SYSTEM FOR MANAGING SECURITY RISKS WITH GENERATIVE ARTIFICIAL INTELLIGENCE

(71) Applicant: Code42 Software, Inc., Minneapolis, MN (US)

(72) Inventors: Christopher Michael Montgomery, Blaine, MN (US); Peter John Lindquist, St. Paul, MN (US); Thomas Anthony Lindquist, Minnetonka, MN (US); Andrew Moravec, Hugo, MN (US); Robert Juncker, Lakeville, MN (US)

(21) Appl. No.: 18/765,713

(22) Filed: Jul. 8, 2024

Related U.S. Application Data
(60) Provisional application No. 63/525,522, filed on Jul. 7, 2023.

(51) Int. Cl. H04L 9/40

(52) U.S. Cl. CPC H04L 63/1433; H04L 63/10; H04L 63/1441

(57) ABSTRACT

A system and method to use generative artificial intelligence to detect potential exfiltration events. A system for exfiltration analysis is configured to receive a plurality of file identifiers of a corresponding plurality of files, the plurality of files related to exfiltration alerts; store information about the plurality of files in a forensic file data store, the forensic file data store used to provide contextual information for a large language model (LLM); receive an exfiltration query from a user of the system; and produce a generative output using the LLM based on the exfiltration query and the contextual information.

### PRIORITY APPLICATIONS

This application claims the benefit of priority of U.S. Provisional Patent Application Ser. No. 63/525,522, filed Jul. 7, 2023, the content of which is incorporated herein by reference in its entirety.

### TECHNICAL FIELD

Embodiments of the present disclosure relate generally to computer security, more particularly, but not by way of limitation, to providing systems for managing security risks with generative artificial intelligence.

### BACKGROUND

Companies with valuable data stored electronically such as source code, customer lists, engineering designs, sensitive emails, and other documents are increasingly subject data leaks or data theft. Outsiders may attempt to hack computer networks using viruses; worms; social engineering; or other techniques to gain access to data storage devices where valuable data is stored. Another threat is exfiltration of data by insiders. Data exfiltration is the unauthorized transfer of data. It is a type of data loss, which may expose sensitive, secret, or personal data. These insiders may be motivated to steal employer data by greed, revenge, a desire to help a new employer, or other motivations. Detecting insider threats is particularly difficult because insiders, such as employees or contractors, may have been granted authorized access to the very files they aim to steal. This makes detecting data exfiltration especially difficult due to the numerous available data exfiltration vectors (i.e., pathways) that an employee may use to move data between computing resources. As a result, during the normal course of business, any employee that has access to data, documents, or other digital assets of an organization is a potential risk to the security of those assets.

### BRIEF DESCRIPTION OF THE DRAWINGS

Various ones of the appended drawings merely illustrate example embodiments of the present disclosure and cannot be considered as limiting its scope. Additionally, the headings provided herein are merely for convenience and do not necessarily affect the scope or meaning of the terms used.

FIG. 1 is a block diagram illustrating a system for file analysis, according to an example embodiment.

FIG. 2 is a block diagram illustrating a forensics component of administrative the server system, according to an example embodiment.

FIG. 3 is a flowchart illustrating a method for managing exfiltration alert events, according to an embodiment.

FIG. 4 illustrates a diagrammatic representation of a machine in the form of a computer system within which a set of instructions may be executed for causing the machine to perform any one or more of the methodologies discussed herein, according to an example embodiment.

### DETAILED DESCRIPTION

Several techniques may be used to track the movement of a file within or across an organization or to detect when a file is transmitted through a digital perimeter of an organization. Such techniques may include identifying and tracking entire files based on a digital signature, such as by way of a file digest hash. Such digital signatures are unique to, or are based on, the entire contents of the file. An example of such digital signatures includes MD5 hashes. Other techniques may use file relationships and track one file's location and activity to infer another file's sensitivity. For instance, when a tracked file is copied or moved, techniques may be used to determine whether there is a likelihood that the file contains sensitive content (e.g., content that has financial, intellectual, or other business value to an organization). Other files that are related to the tracked file may also be marked as being potentially sensitive. Another technique may use portions of a file to track its contents. For instance, a system may use large-token text comparisons to determine whether the files in the relationship set contain related content. The techniques may partition related into tokens and compare the tokens to identify intersections. Files that have tokens in common may be flagged as being more or less related.

Regardless of which techniques are used to track file activity, the amount of activity in an organization is overwhelming. With the increased usage of cloud services and offline data repositories, an organizations data may be transmitted to offsite servers on a regular basis. Monitoring and tracking tools are needed to assist human operators to determine which file exfiltration activities are suspicious or benign.

The systems and methods described herein use a novel mechanism to analyze users, files, and file activity in a domain. The domain may be a corporate boundary, network boundary, geographic boundary, or the like. Generative artificial intelligence (AI) provides a mechanism to perform security analysis that is faster, more comprehensive, and less intrusive than other methods. The AI-based analysis discussed herein provides a way to inspect documents, people's activities, and other information in a non-intrusive manner by removing the human from the analysis. In cases where there may be a data violation, then a human may be brought in for review for more heightened analysis or deeper inspection. However, in the vast majority of analytical tasks, the inspection by an AI system is kept in confidence and privacy is ensured.

Generative AI is a type of system that is able to produce content, such as text, images, audio, or other data. Generative AI is often used in a call-and-response model (e.g., through use of prompts and responses). With advanced technologies, new models have been developed. One of these new models is a large language model (LLM), which may use billions or even trillions of parameters.

Generative AI starts with a prompt and returns new content in response to the prompt. The content may be in the form of essays, poems, lyrics, lists, proposed solutions, itineraries, pictures, computer art, audio, or even video. The prompts may be submitted to a generative AI system through an application programming interface (API), which may require special programming or may use a freeform text input control, for example. One example of a generative AI system that uses freeform input controls is ChatGPT (e.g., ChatGPT-3.5 from OpenAI). ChatGPT is a complex chatbot that is able to converse with a human operator to answer questions, reform output, or stimulate conversation.

Generative AI may be used to produce new content in the form of chat responses, images, or the like. Conversely, traditional AI has focused on detecting patterns, making decisions, classifying data, or the like. The systems and methods described herein may combine generative AI with traditional AI to analyze data and produce new content for a human operator.

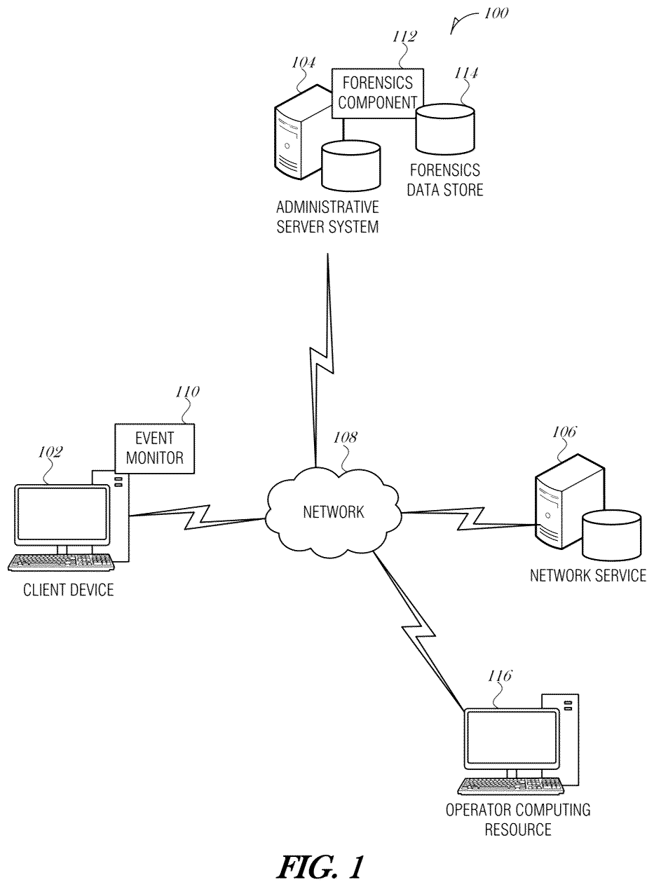

FIG. 1 is a block diagram illustrating a system 100 for file analysis, according to an example embodiment. The system 100 is configured to use artificial intelligence to analyze files and produce an output for a human operator. The system 100 includes a client device 102, an administrative server system 104, and a network service 106, all of which are connected via a data communication network 108. The data communication network 108 may include wired, wireless, local area networks, wide area networks, or the like. Components of the system 100 can communicate using the data communication network 108 or any other suitable data communication channel.

Client device 102 may be any suitable computing resource for accessing files, such as for creating, reading, writing, or deleting one or more files on the client device 102 or at a remote location (e.g., on a network storage device). The client device 102 may be in the form of an endpoint device, a computing server, a mobile device, a laptop, a desktop computing device, or the like.

A user of the client device 102 may interface with the network service 106 to create, modify, or delete files that are hosted at the network service 106. Examples of network services include but are not limited to cloud-based office applications, online storage repositories, online commerce platforms, or the like. The user may use a web browser or other client application executing on the client device 102 to access the network service 106. For instance, the user may use a web browser to navigate to a page for a cloud-based storage and sharing service (e.g., DROPBOX®, ONEDRIVE®, or similar), and upload the files through that page. Alternatively, the user may use a client application to perform similar file functions (e.g., DROPBOX® client application and synchronization functions).

The client device 102 may include an event monitor 110 that is configured to detect or monitor filesystem events. A filesystem event (hereinafter, “event”) can include any operation to create, read, modify, or delete a file, directory, or other filesystem element. In an example, the event monitor 110 is configured to detect file read, file write events, file delete, and file create events. Responsive to detecting a filesystem event, the event monitor 110 is configured to store metadata about the event, such as whether a read or a write operation was performed, an identifier of, or a filesystem reference to, the file on which the operation was performed, a date and time of the event, a user identifier of the person initiating the filesystem event, a filesystem identifier of the file, such as a filename and a file path, a source directory path and a destination directory path, and the like.

Filesystem events may be detected by monitoring input/output (I/O) requests and may perform one or more filtering processes to detect filesystem events and to filter out I/O requests that indicate normal behavior and other behavior that is not indicative of exfiltration. In some examples, the event monitor 110 may use an exfiltration model to determine whether a filesystem event is indicative of exfiltration. Filesystem events that are indicative of exfiltration are further processed, such as by interrogating the web browser or other application or its components to gather contextual information about the user's activities related to the filesystem event.

For example, on devices executing a MICROSOFT® WINDOWS® operating system (O/S), the event monitor 110 may be a kernel filter that is attached to an I/O stack of an O/S kernel. I/O requests of an application are delivered to the driver stack by the O/S to perform the command. A kernel filter acts as a virtual device driver and processes the I/O request. Once processing is finished, the kernel filter passes the I/O request to the next filter or to the next driver in the stack. In this way, a kernel filter has access to all I/O requests within a system; including I/O requests that represent filesystem events that relate to filesystem elements. In some examples, rather than being a filter, the first component may be a minifilter that is registered with a filter manager of an input/output stack of a Windows kernel. In some examples, the minifilter simplifies kernel filter development and management.

As another example, on devices executing an Apple operating system such as a macOS® the event monitor 110 may utilize an event stream that provides I/O requests as one or more events in the stream. For example, an event stream provided by a Basic Security Module (BSM) or Endpoint Security Framework. The event monitor 110 may be implemented as a user mode component or a kernel mode component.

The filesystem events may be examined using an exfiltration model. In some examples, a single event may be used to flag the filesystem event as indicative of exfiltration. For example, if specific files or folders (e.g., sensitive files) are involved in a filesystem event or if a threshold number of files or a threshold number of bytes are transferred to a remote system, then this may be considered highly suspect and indicative of exfiltration. Other suspicious events may include a large number of files being copied to a removable Universal Serial Bus (USB) drive, a large amount of data transfer over a network, and the like. In some examples, a series of filesystem events may be examined with exfiltration models to detect patterns of behavior.

Filesystem events from may be associated with metadata about the filesystem event, the filesystem element, and the application. This metadata may include context information about the user's activities within the application that caused the filesystem event. Context information may include data such as the website that the user used to generate the filesystem event(s) that is indicative of exfiltration, an account that the user was logged into during the event, a directory structure of a cloud-based file sharing or storage site where the files were uploaded to, a recipient of the files (if the site is an email site), and the like. This context information may be obtained, for example, by querying a web browser through an Application Programming Interface (API), querying a database of the web browser, by screen capture techniques to capture a user interface of the web browser, or by analyzing local security logs or filesystem structures.

Account information may be used to determine whether the account associated with the transfer is a work account (which may be permissible) or a personal account (which may not be permissible). This information may be determined using screen scraping techniques—e.g., sites may list the username of the user that is logged in and this information may be scraped. Similarly, information about the user's account on the cloud-based file sharing or storage service such as a directory structure or other files uploaded may also be gathered using screen scraping techniques. If the site is a web-based email, the recipient of the email message may be gathered through scraping techniques as well.

The event monitor 110 may further filter the filesystem event notifications and apply additional detection logic to try and increase accuracy and eliminate false positives. This may include applying one or more permit and reject lists. For example, if a site determined from the browser is in the permit list, the anomaly is not further processed. If the site name determined from the browser is in the reject list, then an alert may be generated, and further exfiltration processing may continue. One or more of the permit lists or reject lists may be utilized alone or in combination.

Filesystem events may be logged at the client device 102 and reported to the administrative server system 104. The reporting may be realtime or may be scheduled. The administrative server system 104 may utilize any events or alerts from the exfiltration application, along with other alerts or signals from detecting other anomalies to determine whether to notify an administrator. For example, a set of rules may determine which alerts, or combination of alerts, may trigger a notification to an administrator. The administrator may be alerted through a management computing device, such as part of a Graphical User Interface (GUI), a text message, an email, or the like.

A forensics component 112 is used to perform forensics on files identified in the alerts to determine relationships to associated files, directories, or users, the type of data contained in the file, the filetype, security settings on the file, and the like. Such data can be stored in a forensic file data store 114 or file backup data store in the administrative server system 104. The forensic file data store 114 may be accessed through a query service.

Operator computing resource 116 can include any computing resource that is configured with one or more software applications to interface with the administrative server system 104 to initiate analysis, such as by transmitting a request or query to the administrative server system 104 in a conversational style dialog.

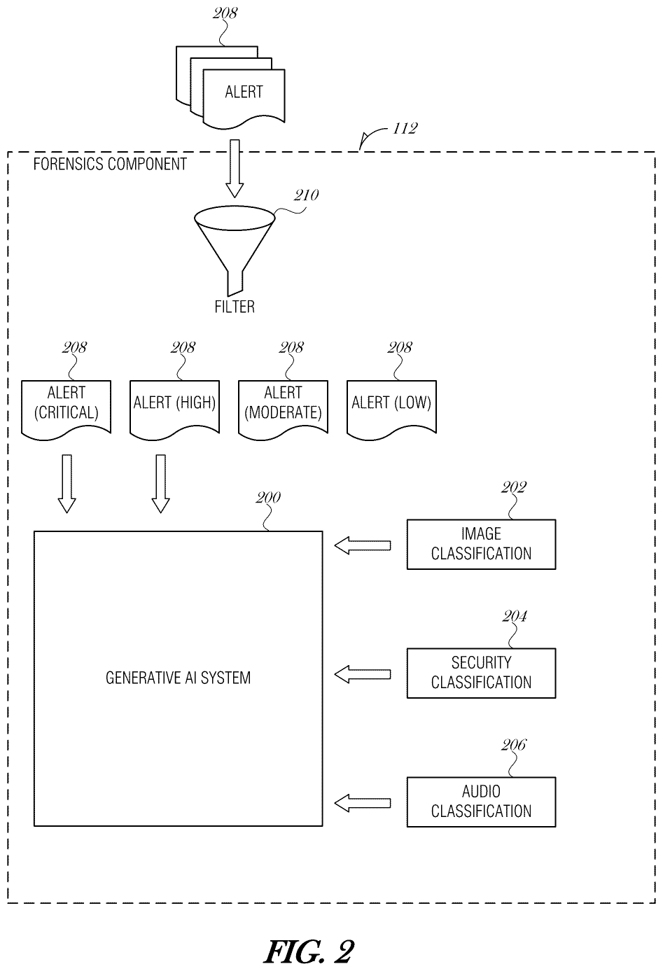

FIG. 2 is a block diagram illustrating a forensics component 112 of the administrative server system 104, according to an example embodiment. The forensics component 112 may be hosted by one or more computers in the administrative server system 104. Because the event monitor 110 is installed at the client device 102 and monitors system level events, the forensics component 112 has visibility into file contents, file attributes, and transaction data that is unavailable to other security platforms. This is a distinct advantage over network monitoring tools that cannot inspect file contents, view login or other contextual data, or perform deep analysis amongst several possible related files.

The forensics component 112 may rely on several different analysis tools, including but not limited to a generative AI system 200, an image classification system 202, a security classification system 204, or audio classification system 206.

The image classification system 202 may be used to analyze an image file to determine the contents of the file. For instance, optical character recognition (OCR), object detection and classification, and other analyses may be used to determine the contents of the file. Questions that may be answered are things like, “What kind of content is in the image?”, “Is this a picture of a whiteboard with sensitive corporate data?”, or “Is this a screenshot of a payroll spreadsheet?”

Security classification system 204 may analyze files identified in an exfiltration alert to determine if the files include intellectual property, personal information (e.g., social security numbers, employee identifiers, bank account numbers, etc.), trade secrets, or other sensitive information. The output from the image classification system 202 may be used by the security classification system 204 to further determine if the file content is sensitive in nature.

Audio classification system 206 may analyze audio files identified in an exfiltration alert to perform speech to text conversion and determine file content. The output from the audio classification system 206 may be used by the security classification system 204 to further determine if the file content is sensitive in nature.

The generative AI system 200 may be used to perform deep analysis of filesystem events for a specific person, a group of people, an entire organization, or the like, in response to a prompt. The prompt may be provided by automation or by a human operator. For instance, a scheduled job may perform automated prompts to the generative AI system 200 at regular intervals and ask the generative AI system 200, “Have there been any critical exfiltration events today?” Alternatively, an API may be used by a person at the operator computing resource 116 to converse with the generative AI system 200 and ask various questions about events.

The generative AI system 200 may be used to inspect a transactional history of a person with respect to one or more files, or inversely, to inspect the history of a file with respect to one or more people who have interacted with the file. Additionally, the generative AI system 200 may be used to analyze a file and its related files or directories. A directory path may be analyzed up or down the hierarchy to identify other files that may be at risk of exfiltration, have been exfiltrated, have sensitive data, or other risk factors.

The generative AI system 200 may be a private or dedicated instance of a publicly or commercially available LLM. The generative AI system 200 may interface with various services of a cloud computing infrastructure including an interface to a LLM, such as ChatGPT by OpenAI, Bard by Google®, PaLM 2 by Google®, LLaMA2 ((Large Language Model Meta AI), Zephyr, Mistral, or other generative artificial intelligence (AI) systems and corresponding LLM tools. The LLM may be trained or fine-tuned on a particular data set. For instance, the generative AI system 200 may be trained using files found in a corporate's filesystem. Such training provides tailored results for queries. A private or dedicated instance of an LLM also provides privacy so file contents, which may include sensitive corporate or personal information, are not exposed to a publicly available LLM environment.

An advantage of using an AI-based system is that the contents of files are not exposed to human operators until the investigation proceeds to a tipping point where human involvement is needed. Up to that point, the privacy of individuals is maintained because the analysis of any file contents is performed by system tools first. With generative AI, the system may provide a summary of the file content without disclosing sensitive information.

Contents of business files may be chunked. Content chunking is a process to separate content into smaller segments, which are easier for AI to process. In an example, a document is chunked based on semantic chunking. The granularity of the chunks may be based on the design and limitations of the system. In an example, chunk size or chunk resolution may be provided as input by a user. Chunk size may be adjusted based on the number of total tokens a model is capable of processing (e.g., context window, 4096 tokens for GPT-3.5 models, 8192 tokens in GPT-4-8 k models, and 32,768 tokens for GPT-4-32 k) and how much context or granular semantic information is needed. Various chunking algorithms may be used, such as naïve splitting (e.g., using an arbitrary delimiter, such as newline or period, to chunk into sentence structures), Natural Language Toolkit (NLTK) (another sentence-level tokenizer), spaCy (another sentence-level tokenizer with context preservation), recursive chunking (e.g., using a hierarchical and iterative process), Markdown (e.g., using a markup language to indicate headings, lists, code blocks, sections, etc., to chunk content), LaTex chunking (e.g., using LaTex commands and environments to create chunks), etc.

Alerts 208 may be initially classified into various risk levels (or risk scores), such as low, moderate, high, and critical risk. Alert classification may be performed by language analysis tools and then executing rules that are defined by an administrator to classify an alert. In an example, alerts 208 are filtered by filter 210 and the generative AI system 200 is used to analyze more important alerts 208 (e.g., only analyze high and critical risk alerts). The generative AI system 200 may provide recommendations to a human security analyst. Visualizations may be used to better organize the alerts 208, the exfiltration vectors (e.g., source/destination of file transfer), and other context information (e.g., user information, file type, file contents, create/modify date of file changes, directory path, etc.).

It is understood that the generative AI system 200 may analyze file transaction history, user activities, alerts or events generated by a client platform, or other information, and may not create an alert for a human operator. Analysis may be based, at least in part, on a vector analysis of content chunks. Content chunks are vectorized using a text-to-vector operation, such as Word2Vec, text-embedding-ada-002 by OpenAI, SentenceTransformers and SBERT for Python derived from BERT (Bidirectional Encoder Representations from Transformers) by Google, or another technique to create text embeddings. The resulting vectors are stored in a vector database (or vector store), which enables fast matching between embeddings. Example vector database include, but are not limited to PineCode, Weaviate, and the like.

Embeddings are vectors (or arrays of numbers) that represent the contextual meaning of the tokens. A token may be a word, group of words, sentence, or paragraph, depending on how the chunking was performed. Embeddings are derived from the parameters or the weights of the AI model. The embeddings are used to encode and decode the input and output texts. Embeddings can help the AI model to understand the semantic and syntactic relationships between the tokens, and to generate more relevant and coherent texts. Embeddings are an important component of the transformer architecture that GPT-based models use.

To compare the one or more file contents to the one or more rules or policies, a prompt (e.g., query) is used to compare embeddings of a content chunk with embeddings of a rule or policy chunk. A prompt may be submitted to a vector database to initiate the vector comparisons. An application programming interface (API) may be used to streamline the process of chunk comparison. The API may also be used to batch comparisons. Chunks are compared using a vector comparison operation, such as a dot product, cosine similarity, soft cosine similarity, Euclidean distance, or the like. The comparison produces a similarity score. Similarity scores that fall below a threshold may be ignored as being directly contrary, irrelevant, opposite, or unrelated.

In some cases, the risk level/score may be reduced or as a result of analysis. In operation, the AI-based result (e.g., similarity score) informs the risk score, which in turn is used to raise or lower the risk score. So, an event may have an associated risk score increase or decrease, in terms of its level of assumed risk as a result.

Alerts 208 may be used to initiate post-analysis processes, such as sending an alert to a human resources department, sending an educational video to a user to inform or instruct the user of procedures to avoid risk activities, interface with network utilities or computer access control modules to block access to network assets, remove user account privileges, restrict access to certain directories, or the like. Mitigation activities may be automated or may be implemented manually with the use of an administrative dashboard.

### Use Cases

Use Case #1: a generative AI system 200 may be trained using security policies, legal documents, user agreements, or the like. Given this contextual legal and corporate rules context, the generative AI system 200 may be queried for users that have violated the rules or policies that were included in the training data.

Use Case #2: a generative AI system 200 may be directed to send instructional videos to anyone that has violated a policy that resulted in an alert risk of low or moderate.

Use Case #3: a security analyst may use the generative AI system 200 to ask about potential risks, such as common risk scenarios in their organization or commonly violated policies found in the organization. Further, the generative AI system 200 may be directed to alert the security analyst of any common or regularly violated policies.

Use Case #4: a security analyst may use the generative AI system 200 to translate filenames from one language to another (e.g., from French to English).

Use Case #5: a security analyst may use the generative AI system 200 to identify MIME type mismatches. For instance, a person who is attempting to avoid detection of exfiltration, may rename a spreadsheet document as an image file. However, file analysis may determine that the contents of the file are in a certain format (e.g., spreadsheet) even though the filename or file extension indicates an image file.

Use Case #6: a security analyst may use the generative AI system 200 to query whether any files that are potentially being exfiltrated include code that has intellectual property.

Use Case #7: a security analyst may use the generative AI system 200 to query whether any files include screenshots or business premises (e.g., a boardroom, a lab, a computer screen, or a whiteboard).

Use Case #8: a security analyst may use the generative AI system 200 to query which users may represent higher risk to a business.

Use Case #9: a security analyst may train the generative AI system 200 with written data retention policies and have the generative AI system 200 create alerts for events that violate the policies.

The processes described herein can include any other steps or operations for implementing the techniques of the present disclosure. While the operations processes described in the discussed processes are shown as happening sequentially in a specific order, in other examples, one or more of the operations may be performed in parallel or in a different order. Additionally, one or more operations may be repeated two or more times.

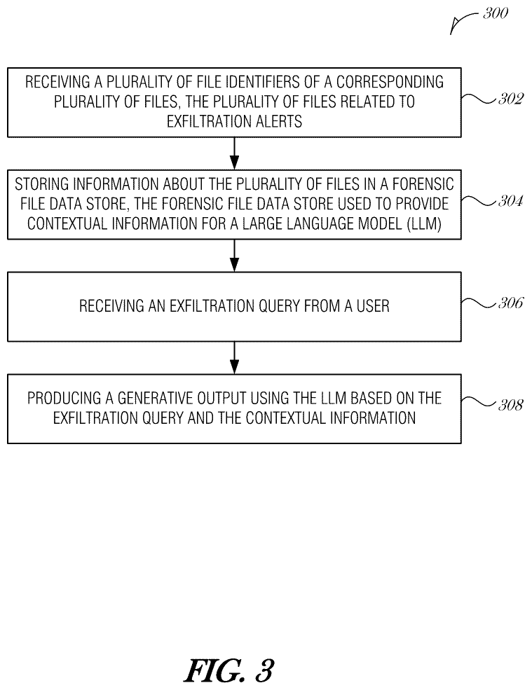

FIG. 3 is a flowchart illustrating a method 300 for managing exfiltration alert events, according to an embodiment. The method 300 may be performed by administrative server system 104, generative AI system 200, or another compute device. The method 300 provides for exfiltration analysis of various events.

At 302, the method 300 includes the operation of receiving a plurality of file identifiers of a corresponding plurality of files, the plurality of files related to exfiltration alerts. In an embodiment, an exfiltration alert of the exfiltration alerts is based on at least one filesystem event. In a further embodiment, the at least one filesystem event includes an operation to create, read, modify, or delete a filesystem element. In a related embodiment, an exfiltration alert of the exfiltration alerts is based on an exfiltration model used to determine whether the at least one filesystem event is indicative of exfiltration.

At 304, the method 300 includes the operation of storing information about the plurality of files in a forensic file data store, the forensic file data store used to provide contextual information for a large language model (LLM). In an embodiment, the LLM is a commercially available model fine-tuned using the contextual information.

At 306, the method 300 includes the operation of receiving an exfiltration query from a user. The query may be in the form of a question, a directive, or a type of request.

At 308, the method 300 includes the operation of producing a generative output using the LLM based on the exfiltration query and the contextual information. In an embodiment, producing the generative output includes the operations of vectorizing the exfiltration query to produce a vector representation of the exfiltration query and performing a vector comparison of the vector representation of the exfiltration query and vector representations of the contextual information. In a further embodiment, the vector comparison is one of: a dot product operation, a cosine similarity operation, or a soft cosine similarity operation.

In an embodiment, the method 300 includes the operations of generating a risk score of an activity related to at least one of the exfiltration alerts. In a further embodiment, the method 300 includes the operation of initiating a mitigation function based on the risk score. In an embodiment, initiating the mitigation function includes alerting a human administrator. In a related embodiment, initiating the mitigation function includes transmitting an educational video to a user related to the activity. In a related embodiment, initiating the mitigation function includes restricting access to network resources for a user related to the activity.

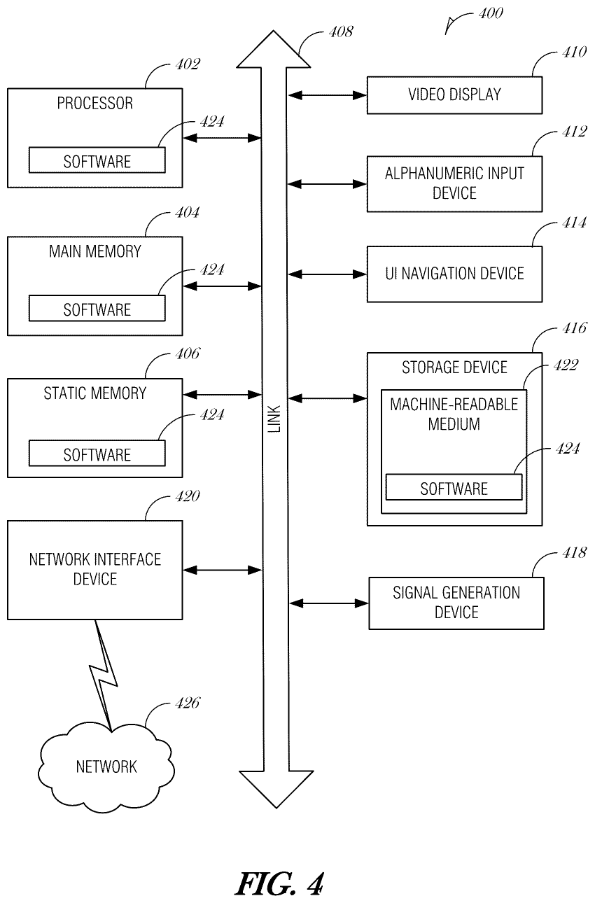

FIG. 4 illustrates a diagrammatic representation of a machine in the form of a computer system within which a set of instructions may be executed for causing the machine to perform any one or more of the methodologies discussed herein, according to an example of the present disclosure. The computer system 400 is an example of one or more of the computing resources discussed herein.

In alternative examples, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 400 includes at least one processor 402 (e.g., a central processing unit (CPU), a graphics processing unit (GPU) or both, processor cores, compute nodes, etc.), a main memory 404 and a static memory 406, which communicate with each other via a link 408 (e.g., bus). The computer system 400 may further include a video display unit 410, an alphanumeric input device 412 (e.g., a keyboard), and a user interface (UI) navigation device 414 (e.g., a mouse). In one example, the video display unit 410, input device 412 and UI navigation device 414 are incorporated into a touch screen display. The computer system 400 may additionally include a storage device 416 (e.g., a drive unit), such as a global positioning system (GPS) sensor, compass, accelerometer, gyrometer, magnetometer, or other sensors.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the computer system 400, with the main memory 404, static memory 406, and the processor 402 also constituting machine-readable media.

While the machine-readable medium 422 is illustrated in an example to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the -readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any example herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

### Examples

Example 1 is a system for exfiltration analysis, the system comprising: a processor subsystem; and memory including instructions, which when executed by the processor subsystem, cause the processor subsystem to: receive a plurality of file identifiers of a corresponding plurality of files, the plurality of files related to exfiltration alerts; store information about the plurality of files in a forensic file data store, the forensic file data store used to provide contextual information for a large language model (LLM); receive an exfiltration query from a user of the system; and produce a generative output using the LLM based on the exfiltration query and the contextual information.

In Example 2, the subject matter of Example 1 includes, wherein an exfiltration alert of the exfiltration alerts is based on at least one filesystem event.

In Example 3, the subject matter of Example 2 includes, wherein the at least one filesystem event includes an operation to create, read, modify, or delete a filesystem element.

In Example 4, the subject matter of Examples 2-3 includes, wherein an exfiltration alert of the exfiltration alerts is based on an exfiltration model used to determine whether the at least one filesystem event is indicative of exfiltration.

In Example 5, the subject matter of Examples 1-4 includes, wherein the LLM is a commercially available model fine-tuned using the contextual information.

In Example 6, the subject matter of Examples 1-5 includes, wherein to produce the generative output, the processor subsystem is to: vectorize the exfiltration query to produce a vector representation of the exfiltration query; and perform a vector comparison of the vector representation of the exfiltration query and vector representations of the contextual information.

In Example 7, the subject matter of Example 6 includes, wherein the vector comparison is one of: a dot product operation, a cosine similarity operation, or a soft cosine similarity operation.

In Example 8, the subject matter of Examples 1-7 includes, wherein the processor subsystem is to generate a risk score of an activity related to at least one of the exfiltration alerts.

In Example 9, the subject matter of Example 8 includes, wherein the processor subsystem is to initiate a mitigation function based on the risk score.

In Example 10, the subject matter of Example 9 includes, wherein to initiate the mitigation function, the processor subsystem is to alert a human administrator.

In Example 11, the subject matter of Examples 9-10 includes, wherein to initiate the mitigation function, the processor subsystem is to transmit an educational video to a user related to the activity.

In Example 12, the subject matter of Examples 9-11 includes, wherein to initiate the mitigation function, the processor subsystem is to restrict access to network resources for a user related to the activity.

Example 13 is a method for exfiltration analysis, the method comprising: receiving a plurality of file identifiers of a corresponding plurality of files, the plurality of files related to exfiltration alerts; storing information about the plurality of files in a forensic file data store, the forensic file data store used to provide contextual information for a large language model (LLM); receiving an exfiltration query from a user; and producing a generative output using the LLM based on the exfiltration query and the contextual information.

In Example 14, the subject matter of Example 13 includes, wherein an exfiltration alert of the exfiltration alerts is based on at least one filesystem event.

In Example 15, the subject matter of Example 14 includes, wherein the at least one filesystem event includes an operation to create, read, modify, or delete a filesystem element.

In Example 16, the subject matter of Examples 14-15 includes, wherein an exfiltration alert of the exfiltration alerts is based on an exfiltration model used to determine whether the at least one filesystem event is indicative of exfiltration.

In Example 17, the subject matter of Examples 13-16 includes, wherein the LLM is a commercially available model fine-tuned using the contextual information.

In Example 18, the subject matter of Examples 13-17 includes, wherein producing the generative output comprises: vectorizing the exfiltration query to produce a vector representation of the exfiltration query; and performing a vector comparison of the vector representation of the exfiltration query and vector representations of the contextual information.

In Example 19, the subject matter of Example 18 includes, wherein the vector comparison is one of: a dot product operation, a cosine similarity operation, or a soft cosine similarity operation.

In Example 20, the subject matter of Examples 13-19 includes, generating a risk score of an activity related to at least one of the exfiltration alerts.

In Example 21, the subject matter of Example 20 includes, initiating a mitigation function based on the risk score.

In Example 22, the subject matter of Example 21 includes, wherein initiating the mitigation function includes alerting a human administrator.

In Example 23, the subject matter of Examples 21-22 includes, wherein initiating the mitigation function includes transmitting an educational video to a user related to the activity.

In Example 24, the subject matter of Examples 21-23 includes, wherein to initiating the mitigation function includes restricting access to network resources for a user related to the activity.

Example 25 is a non-transitory machine-readable medium for exfiltration analysis, including instructions, which when executed by a machine, cause the machine to: receive a plurality of file identifiers of a corresponding plurality of files, the plurality of files related to exfiltration alerts; store information about the plurality of files in a forensic file data store, the forensic file data store used to provide contextual information for a large language model (LLM); receive an exfiltration query from a user; and produce a generative output using the LLM based on the exfiltration query and the contextual information.

In Example 26, the subject matter of Example 25 includes, wherein an exfiltration alert of the exfiltration alerts is based on at least one filesystem event.

In Example 27, the subject matter of Example 26 includes, wherein the at least one filesystem event includes an operation to create, read, modify, or delete a filesystem element.

In Example 28, the subject matter of Examples 26-27 includes, wherein an exfiltration alert of the exfiltration alerts is based on an exfiltration model used to determine whether the at least one filesystem event is indicative of exfiltration.

In Example 29, the subject matter of Examples 25-28 includes, wherein the LLM is a commercially available model fine-tuned using the contextual information.

In Example 30, the subject matter of Examples 25-29 includes, wherein the instructions to produce the generative output, include instructions to: vectorize the exfiltration query to produce a vector representation of the exfiltration query; and perform a vector comparison of the vector representation of the exfiltration query and vector representations of the contextual information.

In Example 31, the subject matter of Example 30 includes, wherein the vector comparison is one of: a dot product operation, a cosine similarity operation, or a soft cosine similarity operation.

In Example 32, the subject matter of Examples 25-31 includes, instructions to generate a risk score of an activity related to at least one of the exfiltration alerts.

In Example 33, the subject matter of Example 32 includes, instructions to initiate a mitigation function based on the risk score.

In Example 34, the subject matter of Example 33 includes, wherein the instructions to initiate the mitigation function includes instructions to alert a human administrator.

In Example 35, the subject matter of Examples 33-34 includes, wherein the instructions to initiate the mitigation function includes instructions to transmit an educational video to a user related to the activity.

In Example 36, the subject matter of Examples 33-35 includes, wherein the instructions to initiate the mitigation function includes instructions to restrict access to network resources for a user related to the activity.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

### Additional Notes:

The above detailed description includes references to the accompanying drawings, which form a part of the detailed description. The drawings show, by way of illustration, specific examples that may be practiced. These examples are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other examples may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as examples may feature a subset of said features. Further, examples may include fewer features than those disclosed in a particular example. Thus, the following claims are hereby incorporated into the Detailed Description, with a claim standing on its own as a separate example. The scope of the examples disclosed herein is to be determined with reference to the appended claims, along with the full scope of equivalents to which such claims are entitled.

What is claimed is:

1. A system for exfiltration analysis, the system comprising:
a processor subsystem; and
memory including instructions, which when executed by the processor subsystem, cause the processor subsystem to:
receive a plurality of file identifiers of a corresponding plurality of files, the plurality of files related to exfiltration alerts;
store information about the plurality of files in a forensic file data store, the forensic file data store used to provide contextual information for a large language model (LLM);
receive an exfiltration query from a user of the system; and
produce a generative output using the LLM based on the exfiltration query and the contextual information.

2. The system of claim 1, wherein an exfiltration alert of the exfiltration alerts is based on at least one filesystem event.

3. The system of claim 2, wherein the at least one filesystem event includes an operation to create, read, modify, or delete a filesystem element.

4. The system of claim 2, wherein an exfiltration alert of the exfiltration alerts is based on an exfiltration model used to determine whether the at least one filesystem event is indicative of exfiltration.

5. The system of claim 1, wherein the LLM is a commercially available model fine-tuned using the contextual information.

6. The system of claim 1, wherein to produce the generative output, the processor subsystem is to:
vectorize the exfiltration query to produce a vector representation of the exfiltration query; and
perform a vector comparison of the vector representation of the exfiltration query and vector representations of the contextual information.

7. The system of claim 6, wherein the vector comparison is one of: a dot product operation, a cosine similarity operation, or a soft cosine similarity operation.

8. The system of claim 1, wherein the processor subsystem is to generate a risk score of an activity related to at least one of the exfiltration alerts.

9. The system of claim 8, wherein the processor subsystem is to initiate a mitigation function based on the risk score.

10. The system of claim 9, wherein to initiate the mitigation function, the processor subsystem is to alert a human administrator.

11. The system of claim 9, wherein to initiate the mitigation function, the processor subsystem is to transmit an educational video to a user related to the activity.

12. The system of claim 9, wherein to initiate the mitigation function, the processor subsystem is to restrict access to network resources for a user related to the activity.

13. A method for exfiltration analysis, the method comprising:
receiving a plurality of file identifiers of a corresponding plurality of files, the plurality of files related to exfiltration alerts;
storing information about the plurality of files in a forensic file data store, the forensic file data store used to provide contextual information for a large language model (LLM);
receiving an exfiltration query from a user of the system; and
producing a generative output using the LLM based on the exfiltration query and the contextual information.

14. The method of claim 13, wherein an exfiltration alert of the exfiltration alerts is based on at least one filesystem event.

15. The method of claim 14, wherein the at least one filesystem event includes an operation to create, read, modify, or delete a filesystem element.

16. The method of claim 14, wherein an exfiltration alert of the exfiltration alerts is based on an exfiltration model used to determine whether the at least one filesystem event is indicative of exfiltration.

17. The method of claim 13, wherein the LLM is a commercially available model fine-tuned using the contextual information.

18. The method of claim 13, comprising generating a risk score of an activity related to at least one of the exfiltration alerts.

19. The method of claim 18, comprising initiating a mitigation function based on the risk score.

20. A non-transitory machine-readable medium for exfiltration analysis, including instructions, which when executed by a machine, cause the machine to:
receive a plurality of file identifiers of a corresponding plurality of files, the plurality of files related to exfiltration alerts;
store information about the plurality of files in a forensic file data store, the forensic file data store used to provide contextual information for a large language model (LLM);
receive an exfiltration query from a user; and
produce a generative output using the LLM based on the exfiltration query and the contextual information.
